(19) United States
(12) Patent Application Publication
(10) Pub. No.: US 2024/0027692 A1
(43) Pub. Date: Jan. 25, 2024

(54) OPTICAL CONNECTOR CLEANING TOOL

(71) Applicant: NIPPON TELEGRAPH AND TELEPHONE CORPORATION, Tokyo (JP)

(72) Inventors: Chisato FUKAI, Musashino-shi, Tokyo (JP); Kazunori KATAYAMA, Musashino-shi, Tokyo (JP); Masaaki TAKAYA, Musashino-shi, Tokyo (JP); Yoshiteru ABE, Musashino-shi, Tokyo (JP); Ryo KOYAMA, Musashino-shi, Tokyo (JP)

(73) Assignee: NIPPON TELEGRAPH AND TELEPHONE CORPORATION, Tokyo (JP)

(21) Appl. No.: 17/424,731

(22) PCT Filed: Jan. 10, 2020
(86) PCT No.: PCT/JP2020/000591

§ 371 Date: Jan. 17, 2022

(30) Foreign Application Priority Data
Jan. 25, 2019 (JP) 2019-011387

(51) Int. Cl. G02B 6/38; B08B 1/00

(52) U.S. Cl. CPC G02B 6/3866; B08B 1/008; B08B 2240/02

(57) ABSTRACT

An object is to provide an optical connector cleaning tool capable of simultaneously and appropriately cleaning an end surface and a side surface of a ferrule of an optical connector plug. The optical connector cleaning tool according to the present invention includes an end surface cleaning section including a cleaning sheet for cleaning a ferrule end surface of an optical connector plug, a side surface cleaning section including a cleaning thread bundle (or cleaning sheet) for cleaning a ferrule side surface of the optical connector plug, and a mechanism that reveals a new cleaning sheet and a new cleaning thread bundle (or cleaning sheet) at a predetermined position after each cleaning operation.

### TECHNICAL FIELD

The present disclosure relates to an optical connector cleaning tool for removing a foreign substance attached to an end surface and a side surface of a ferrule of an optical connector plug.

### BACKGROUND ART

At present, information communication has been performed through an optical communication network using optical fibers. In the wiring of the optical communication network, an optical connector is used to connect the optical fibers. In a connection method using the optical connector, optical connector plugs are inserted from both sides of an optical connector adapter, and end surfaces of ferrules of the pair of optical connector plugs inserted from both sides are closely attached inside the optical connector adapter. Thereby, fiber end surfaces of optical fibers incorporated in the respective ferrules are closely attached, and optical signals can be transmitted.

Here, a connection form using the optical connector is primarily connection of an optical transmission and reception device. The optical connector adapter is disposed in a housing of the optical transmission and reception device, and one optical connector plug is incorporated in the optical connector adapter from the inside of the optical transmission and reception device. An optical connector plug that is newly used in connection is inserted into the optical connector adapter in which the optical connector plug is incorporated, and the end surfaces of the ferrules of the respective optical connector plugs are closely attached inside the optical connector adapter. Thereby, the fiber end surfaces of the optical fibers incorporated in the ferrules are closely attached, and the optical signals can be transmitted.

In the connection method using the optical connector, when a foreign substance is attached between the fiber end surfaces of the optical fibers inserted from both sides of the optical connector adapter, connection characteristics are deteriorated, such as an increase in connection loss or reflection. As a result, the transmission performance of the optical signals is deteriorated.

In transmission of high power light of an optical amplifier or the like, in a case where a foreign substance is attached to an optical fiber core portion of the end surface of the ferrule of the optical connector plug, high power light blocked by the foreign substance generates heat to melt the optical fiber along with the foreign substance, and the shape of the fiber end surface is deformed. Thus, the connection characteristics are deteriorated, as a result, causing deterioration of the transmission performance of the optical signals. For this reason, the optical connector is cleaned at the time of connection.

In a cleaning technique of an optical connector, a cleaning tool (for example, see Patent Literature 1) is known that cleans an end surface of a ferrule of an optical connector plug using a cleaning sheet. Furthermore, a cleaning tool (for example, see Patent Literature 2) is known in which a cleaning fabric is disposed inside a recess, into which a ferrule of an optical connector plug is inserted, to clean an end surface and a side surface of the ferrule of the optical connector plug. In addition, a cleaning tool (for example, see Patent Literature 3) is known that cleans an end surface of a ferrule of an optical connector by feeding gas from an air nozzle. Moreover, a cleaning tool (for example, see Patent Literature 4) is known that cleans an end surface of an optical connector plug and an end surface of a ferrule of an optical connector plug incorporated in an optical connector adapter using a cleaning thread.

### CITATION LIST

### Patent Literature

Patent Literature 1: JP 2001-246343 A
Patent Literature 2: JP 2005-258473 A
Patent Literature 3: JP 10-227943 A
Patent Literature 4: WO 2009/119437

### SUMMARY OF THE INVENTION

### Technical Problem

However, in the cleaning tool of the optical connector described in Patent Literature 1, only the end surface of the ferrule of the optical connector plug is cleaned. For this reason, in a case where dust is attached as a foreign substance to the side surface of the ferrule of the optical connector plug, there is a problem in that the dust attached to the side surface of the ferrule is pushed into the optical connector adapter when the optical connector plug is inserted into the optical connector adapter, and the dust is attached to the end surface of the ferrule or the fiber end surface of the optical fiber, causing deterioration of connection performance.

On the other hand, in the cleaning tool of the optical connector described in Patent Literature 2, in a case where force for pushing the ferrule into the recess is insufficient when the ferrule of the optical connector plug is inserted into the recess of the optical connector cleaning tool, there is a problem in that it is difficult to appropriately clean the end surface of the ferrule, and the foreign substance remains on the end surface of the ferrule.

Furthermore, in the cleaning tool of the optical connector described in Patent Literature 3, in a case where pressure of gas ejected from the air nozzle is weak, there is a problem in that it is difficult to appropriately clean the end surface of the ferrule, and dust remains on the end surface of the ferrule.

In addition, in the cleaning tool of the optical connector described in Patent Literature 4, in a case of cleaning the optical connector plug, only the end surface of the ferrule of the optical connector plug is cleaned. Thus, in a case where dust is attached as a foreign substance to the side surface of the ferrule of the optical connector plug before the optical connector plug is inserted into the optical connector adapter, there is a problem in that the dust attached to the side surface of the ferrule is pushed into the optical connector adapter when the optical connector plug is inserted into the optical connector adapter, and the dust is attached to the end surface of the ferrule or the fiber end surface of the optical fiber.

Accordingly, the present invention has been suggested in view of the above-described problems, and an object of the present invention is to provide an optical connector cleaning tool capable of simultaneously and appropriately cleaning an end surface and a side surface of a ferrule of an optical connector plug.

### Means for Solving the Problem

To achieve the above-described object, an optical connector cleaning tool according to the present invention includes an end surface cleaning section including a cleaning sheet for cleaning a ferrule end surface of an optical connector plug, a side surface cleaning section including a cleaning thread bundle (or cleaning sheet) for cleaning a ferrule side surface of the optical connector plug, and a mechanism that reveals a new cleaning sheet and a new cleaning thread bundle (or cleaning sheet) at a predetermined position after each cleaning operation.

Specifically, an optical connector cleaning tool according to the present invention includes an insertion port into which a ferrule of an optical connector plug is inserted, an end surface cleaning band configured to remove dirt on a ferrule end surface of the optical connector plug by friction with the ferrule end surface, a side surface cleaning band configured to remove dirt on a ferrule side surface of the optical connector plug by friction with the ferrule side surface, a cleaning section configured to bring the ferrule end surface and the ferrule side surface of the optical connector plug inserted from the insertion port into contact with portions of the end surface cleaning band and the side surface cleaning band, respectively, and a movement mechanism configured to move the end surface cleaning band and the side surface cleaning band by a given amount, move portions of the end surface cleaning band and the side surface cleaning band revealed in the cleaning section, and reveal new portions of the end surface cleaning band and the side surface cleaning band in the cleaning section.

The optical connector cleaning tool includes the cleaning band for the ferrule end surface and the cleaning band for the ferrule side surface, and can simultaneously clean the ferrule end surface and the ferrule side surface by inserting the ferrule of the optical connector plug. In addition, the portion of the cleaning band used at the time of previous cleaning is moved by the movement mechanism and the new cleaning band is revealed in the cleaning section, whereby it is possible to prevent dirt adhered to the cleaning band at the time of previous cleaning from being re-attached to the ferrule.

Accordingly, the present invention can provide an optical connector cleaning tool capable of simultaneously and appropriately cleaning an end surface and a side surface of a ferrule of an optical connector plug.

For example, the end surface cleaning band is a cleaning sheet, and the side surface cleaning band is a cleaning thread bundle.

Furthermore, the end surface cleaning band and the side surface cleaning band may be cleaning sheets. In this case, it is preferable that the optical connector cleaning tool further include a twist prevention wall configured to prevent the side surface cleaning band from being twisted when the side surface cleaning band is brought into contact with the ferrule side surface, the twist prevention wall being located on a side opposite to a side of the side surface cleaning band that is to be in contact with the ferrule side surface, such that the cleaning sheet is not twisted when the ferrule of the optical connector plug is inserted into the cleaning section.

As a specific structure, the movement mechanism includes a feeding reel configured to feed the end surface cleaning band and the side surface cleaning band, a winding reel configured to wind the end surface cleaning band and the side surface cleaning band, and a drive button configured to drive the winding reel.

As a first form, the optical connector cleaning tool according to the present invention further includes a shutter configured to close the insertion port, wherein the shutter is opened and closed in conjunction with an operation of moving, by the movement mechanism, the end surface cleaning band and the side surface cleaning band by a given amount. It is possible to prevent dust from entering the insertion port during storage of the optical connector cleaning tool.

As a second form, the optical connector cleaning tool according to the present invention further includes a fixing section located in the insertion port, the fixing section being configured to hold the optical connector plug in a state in which the ferrule end surface and the ferrule side surface of the optical connector plug are in contact with portions of the end surface cleaning band and the side surface cleaning band, respectively, wherein, while holding the optical connector plug, the fixing section moves from an initial position to an end position in a movement direction of the end surface cleaning band and the side surface cleaning band in conjunction with an operation of moving, by the movement mechanism, the end surface cleaning band and the side surface cleaning band by a given amount, and returns from the end position to the initial position after the operation of moving, by the movement mechanism, the end surface cleaning band and the side surface cleaning band by the given amount. The ferrule end surface and the cleaning band are automatically rubbed, whereby it is possible to reliably remove dirt on the ferrule end surface.

The fixing section of the optical connector cleaning tool of the second form according to the present invention includes a rotation mechanism configured to rotate the optical connector plug by 180° or more about a ferrule center of the optical connector plug as an axis when the fixing section returns from the end position to the initial position. The ferrule side surface and the cleaning band are automatically rubbed, whereby it is possible to reliably remove dirt on the ferrule side surfaces.

### Effects of the Invention

The present invention can provide an optical connector cleaning tool capable of simultaneously and appropriately cleaning an end surface and a side surface of a ferrule of an optical connector plug.

### BRIEF DESCRIPTION OF DRAWINGS

FIG. 1 is a schematic cross-sectional view illustrating an optical connector cleaning tool according to the present invention.

FIG. 2 is a schematic cross-sectional view illustrating an operation of the optical connector cleaning tool according to the present invention.

FIG. 3 is a schematic cross-sectional view illustrating an operation of the optical connector cleaning tool according to the present invention. FIG. 3(B) is an enlarged view of the vicinity of a cleaning section of FIG. 3(A).

FIG. 4 is a schematic view illustrating a method of cleaning an optical connector plug with the optical connector cleaning tool according to the present invention.

FIG. 5 is a schematic cross-sectional view illustrating an operation of the optical connector cleaning tool according to the present invention.

FIG. 6 is a schematic view illustrating a method of cleaning an optical connector plug with the optical connector cleaning tool according to the present invention.

FIG. 7 is a schematic view illustrating the optical connector cleaning tool according to the present invention.

FIG. 8 is a schematic view illustrating the optical connector cleaning tool according to the present invention.

FIG. 9 is a schematic cross-sectional view illustrating the optical connector cleaning tool according to the present invention.

FIG. 10 is a schematic cross-sectional view illustrating an operation of the optical connector cleaning tool according to the present invention. FIG. 10(B) is an enlarged view of the vicinity of a cleaning section of FIG. 10(A).

FIG. 11 is a schematic cross-sectional view illustrating an operation of the optical connector cleaning tool according to the present invention.

FIG. 12 is a schematic cross-sectional view illustrating an operation of the optical connector cleaning tool according to the present invention.

### DESCRIPTION OF EMBODIMENTS

Embodiments of the present invention will be described with reference to the accompanying drawings. The embodiments described below are examples of the present invention and the present invention is not limited to the embodiments described below. In the present specification and the drawings, components with the same reference signs indicate the same components.

### First Embodiment

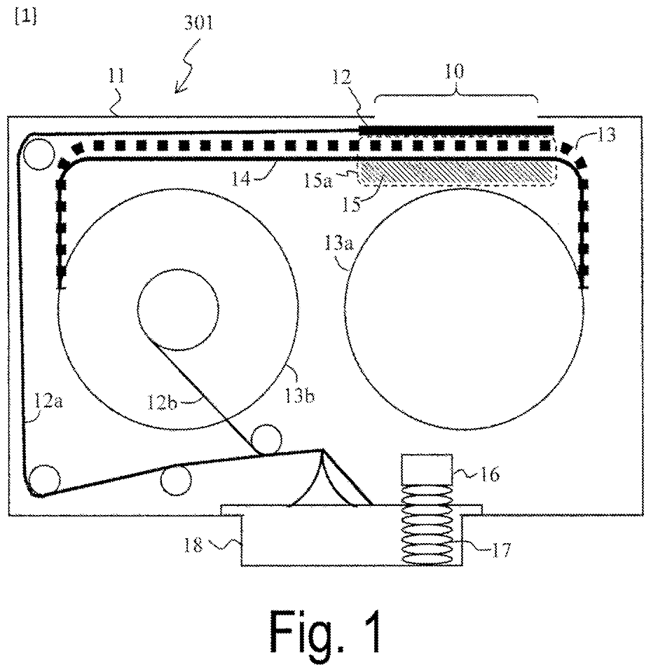

FIG. 1 is a schematic cross-sectional view illustrating an optical connector cleaning tool 301 according to the embodiment. The optical connector cleaning tool 301 includes an insertion port 10, an end surface cleaning band 14, a side surface cleaning band 13, a cleaning section 15a, and a movement mechanism. Here, a ferrule of an optical connector plug is inserted into the insertion port 10. The end surface cleaning band 14 removes dirt on a ferrule end surface of the optical connector plug by friction with the ferrule end surface. The side surface cleaning band 13 removes dirt on a ferrule side surface of the optical connector plug by friction with the ferrule side surface. The cleaning section 15a brings the ferrule end surface and the ferrule side surface of the optical connector plug inserted from the insertion port 10 into contact with portions of the end surface cleaning band 14 and the side surface cleaning band 13, respectively. The movement mechanism moves the end surface cleaning band 14 and the side surface cleaning band 13 by a given amount, moves portions of the end surface cleaning band 14 and the side surface cleaning band 13 revealed in the cleaning section 15a, and reveals new portions of the end surface cleaning band 14 and the side surface cleaning band 13 in the cleaning section 15a.

In the embodiment, the end surface cleaning band 14 is a cleaning sheet and the side surface cleaning band 13 is a cleaning thread bundle. In the following description, a portion of the cleaning section 15a that cleans the ferrule end surface of the optical connector plug is referred to as an “end surface cleaning section”, and a portion of the cleaning section 15a that cleans the ferrule side surface of the optical connector plug is referred to as a “side surface cleaning section”. That is, the optical connector cleaning tool 301 is an example of an optical connector cleaning tool in which the end surface cleaning section of the ferrule of the optical connector plug includes a cleaning sheet and the side surface cleaning section of the ferrule of the optical connector plug includes a cleaning thread bundle.

The optical connector cleaning tool 301 includes a shutter 12, a side surface cleaning band (cleaning thread bundle) 13, an end surface cleaning band (cleaning sheet) 14, a cleaning sheet holding section 15, a spring holding section 16, a spring 17, and a movement mechanism, inside an optical connector cleaning tool housing 11 provided with the optical connector insertion port 10.

The movement mechanism includes a feeding reel 13a that feeds the end surface cleaning band 14 and the side surface cleaning band 13, a winding reel 13b that winds the end surface cleaning band 14 and the side surface cleaning band 13, and a drive button 18 that is provided to drive the winding reel 13b.

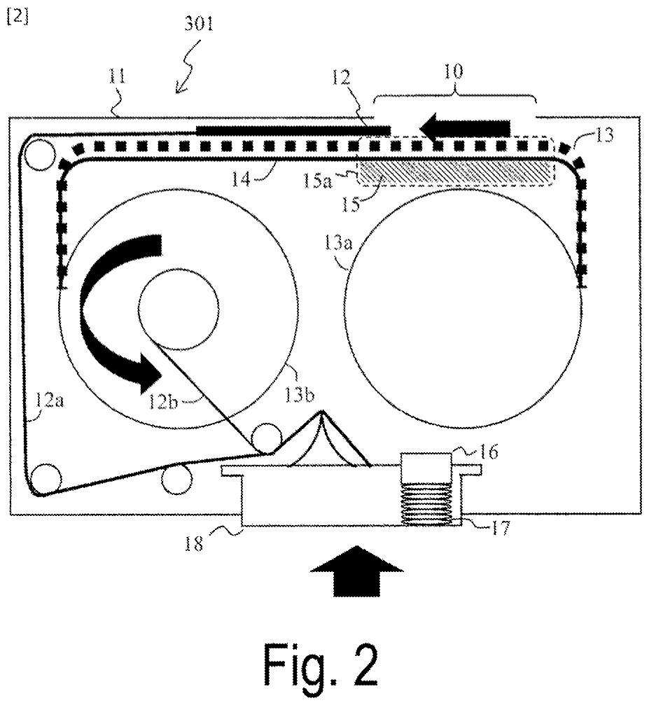

An operation of the optical connector cleaning tool 301 will be described referring to FIGS. 2 to 8. In a case where the side surface cleaning band 13 and the end surface cleaning band 14 are collectively described, these can be referred to as cleaning bands (13, 14).

First, as illustrated in FIG. 2, pressure is applied to the drive button 18 in a direction of an arrow from below, whereby a string 12a for the shutter connected to the drive button 18 is pulled and the shutter 12 is opened from right to left in a direction of an arrow. At the same time, a string 12b for the cleaning thread bundle and the cleaning sheet connected to the drive button 18 is pulled and the winding reel 13b is rotated in a direction of an arrow. Upon rotation of the winding reel 13b, the cleaning bands (13, 14) are wound, and thus new cleaning bands (13, 14) are fed from the feeding reel 13a. For this reason, in the cleaning section 15a, the old portions of the cleaning bands (13, 14) after cleaning are moved to the winding reel 13b, and the new cleaning bands (13, 14) are revealed from the feeding reel 13a.

Here, although the opening and closing of the shutter 12 and the feeding of the cleaning bands (13, 14) are driven by the strings (12a, 12b) connected to the drive button 18, respectively, other methods that enable the opening and closing of the shutter 12 and the feeding of the cleaning bands (13, 14) may be used.

A stopper (not illustrated) is attached to the cleaning bands (13, 14). For this reason, even though the drive button 18 is released and the drive button 18 returns to an original position by the spring 17, the reels (13a, 13b) are not reversely rotated and the cleaning bands (13, 14) do not return to an original position (used portions are not revealed again in the cleaning section 15a). The stopper may be attached to the reels (13a, 13b).

That is, the cleaning thread bundle 13 and the cleaning sheet 14 are fed into the cleaning section 15a from right to left by a length to be used in cleaning with the pressing of the drive button 18, and the portions used in cleaning are further fed from right to left at the time of next cleaning sheet feeding. At the time of ferrule cleaning, this mechanism allows the new clean cleaning thread bundle 13 and cleaning sheet 14 to be always revealed in the cleaning section with the pressing of the drive button 18.

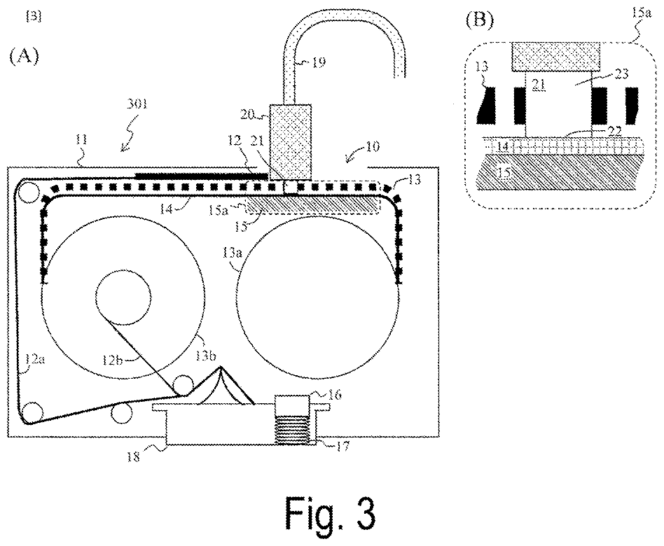

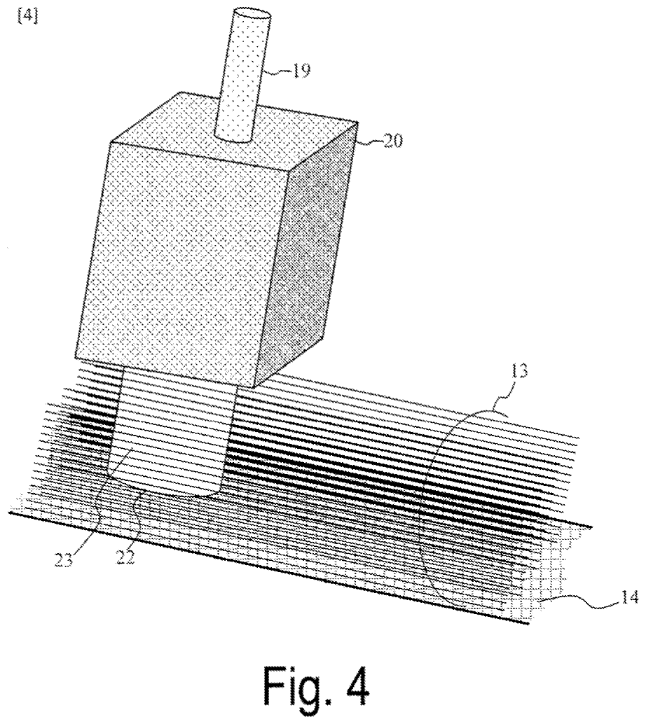

Next, as illustrated in FIG. 3, after the drive button 18 is pushed and the new clean cleaning bands (13, 14) are revealed in the cleaning section 15a, a ferrule 21 of an optical connector plug 20 attached to an optical fiber cord 19 is inserted into the insertion port 10. FIG. 4 is a diagram illustrating a state in which the ferrule 21 of the optical connector plug 20 is inserted into the cleaning section 15a from the insertion port 10. When the ferrule 21 is inserted into the cleaning section 15a, the ferrule 21 passes through the cleaning thread bundle 13. When passing through the cleaning thread bundle 13, a ferrule side surface 23 is rubbed against the cleaning thread bundle 13 and dirt on the ferrule side surface 23 is scraped with the cleaning thread bundle 13. Here, the ferrule 21 of the optical connector plug 20 is pushed into the cleaning section 15a until a ferrule end surface 22 reaches the cleaning sheet 14. The cleaning sheet holding section 15 is disposed below the cleaning sheet 14. For this reason, even though the ferrule 21 of the optical connector plug 20 is pressed against the cleaning sheet 14, the ferrule end surface 22 does not deform or pass through the cleaning sheet 14.

Here, although the optical fiber cord 19 is a single mode fiber having a zero-dispersion wavelength, for example, in a 1.3 μm band, other optical fibers may be used. Although examples of the optical connector plug 20 include an FC shape optical connector plug and an SC shape optical connector plug for a single core, other optical connector plugs for a single core and a multi-core may be used.

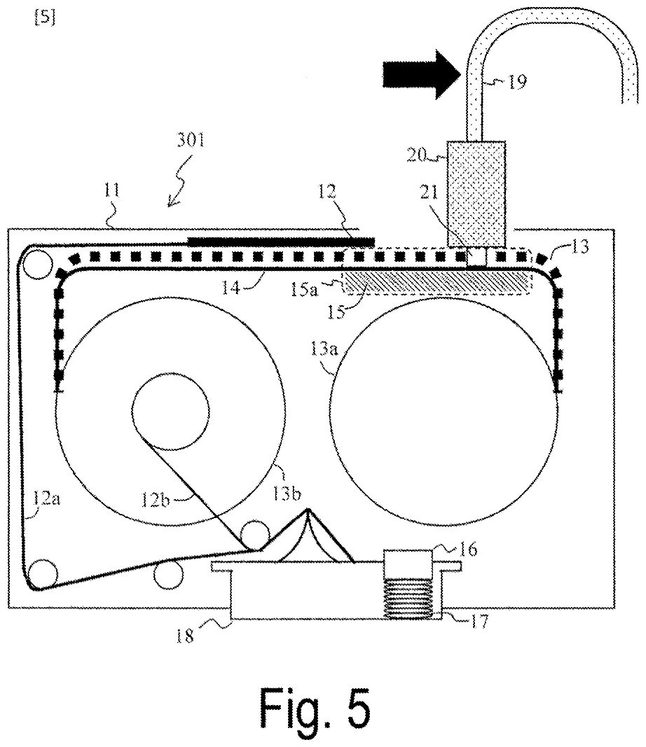

Next, as illustrated in FIG. 5, the optical connector plug 20 is slid from left to right in a direction of an arrow while the ferrule end surface 22 remains pressed against the cleaning sheet 14, whereby the ferrule end surface 22 and the ferrule side surface 23 are cleaned by the cleaning sheet 14 and the cleaning thread bundle 13, respectively.

### Second Embodiment

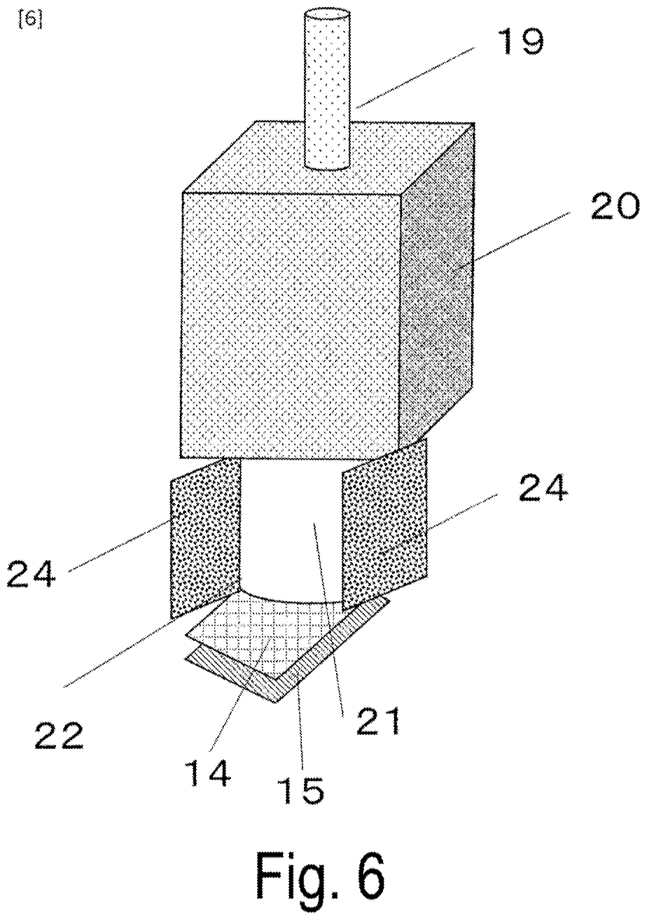

A structure of an optical connector cleaning tool of the embodiment is the same as the structure of the optical connector cleaning tool 301 of FIG. 1, but has a feature in which both of a side surface cleaning band 24 that removes dirt on a ferrule side surface 23 and an end surface cleaning band 14 that removes dirt on a ferrule end surface 22 are cleaning sheets. FIG. 6 is a diagram illustrating a state in which a ferrule 21 of an optical connector plug 20 is inserted into a cleaning section 15a from an insertion port 10 of the optical connector cleaning tool of the embodiment.

Two cleaning sheets that are the side surface cleaning bands 24 are disposed. Specifically, as illustrated in FIG. 6, each cleaning sheet 24 is disposed to be perpendicular to the cleaning sheet 14 and parallel to a longitudinal direction of the cleaning sheet 14 with a width corresponding to the length of the ferrule 21. The ferrule 21 inserted to reach the cleaning sheet 14 between the two cleaning sheets 24 is slid, whereby the ferrule side surface 23 is cleaned with the cleaning sheets 24, and the ferrule end surface 22 is cleaned with the cleaning sheet 14.

Here, it is preferable that the optical connector cleaning tool further include a twist prevention wall 25 that prevents each side surface cleaning band 24, which removes dirt on the ferrule side surface 23, from being twisted when the side surface cleaning band 24 is brought into contact with the ferrule side surface 23. Of the side surface cleaning band 24, which removes dirt on the ferrule side surface 23, the twist prevention wall 25 is provided on a side opposite to a side that is in contact with the ferrule side surface 23.

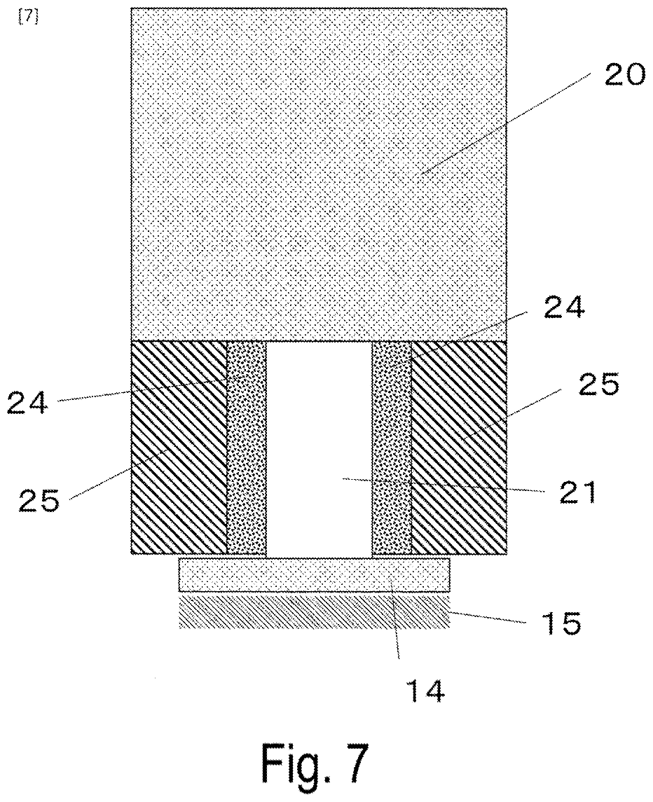

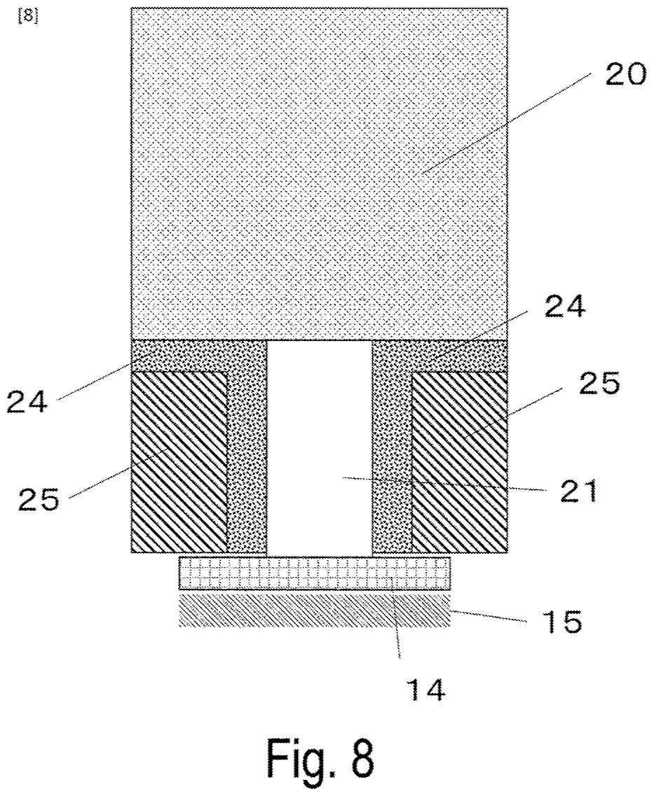

FIG. 7 is a diagram illustrating the twist prevention walls 25. Each twist prevention wall 25 is disposed on the back side of the corresponding cleaning sheet 24 (a side opposite to a side which cleans the ferrule side surface 23). Since the twist prevention wall 25 prevents deformation of the cleaning sheet 24, the cleaning sheet 24 is not twisted when the ferrule 21 is inserted or cleaned. For example, as illustrated in FIG. 8, each cleaning sheet 24 can be fixed to cover the sides of the twist prevention wall 25 facing the optical connector plug 20 and the ferrule 21.

Grooves (not illustrated) are formed in the twist prevention wall 25, and the ends of the cleaning sheet 24 are inserted into the grooves, whereby it is possible to prevent entanglement when the ferrule 21 is inserted between the two cleaning sheets 24. Although the twist prevention wall 25 can be formed from an elastic material, such as sponge or rubber to make the cleaning sheet 24 be closely attached to the ferrule side surface 23, other methods may be used.

### Third Embodiment

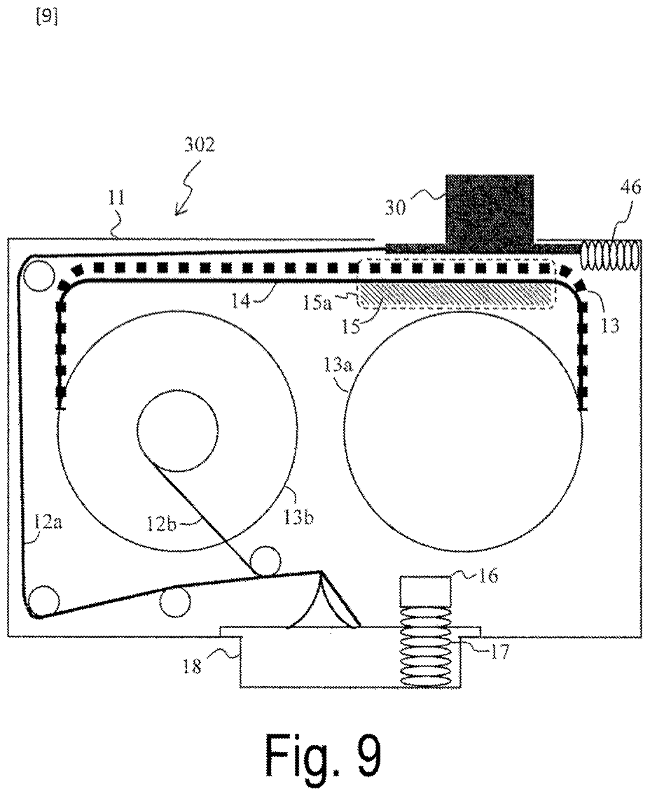

FIG. 9 is a schematic cross-sectional view illustrating an optical connector cleaning tool 302 of the embodiment. The optical connector cleaning tool 302 is different from the optical connector cleaning tool 301 of FIG. 1 in that the optical connector cleaning tool 302 further includes a fixing section 30. Here, the fixing section 30 is disposed in an insertion port 10 and holds an optical connector plug 20 in a state in which a ferrule end surface 22 and a ferrule side surface 23 of the optical connector plug 20 are in contact with portions of cleaning bands (13, 14). In the embodiment, the side surface cleaning band 13 that removes dirt on the ferrule side surface 23 is a cleaning thread bundle, and the end surface cleaning band 14 that removes dirt on the ferrule end surface 22 is a cleaning sheet. That is, the optical connector cleaning tool 302 is an example of an optical connector cleaning tool in which the end surface cleaning section of the ferrule of the optical connector plug includes a cleaning sheet and the side surface cleaning section of the ferrule of the optical connector plug includes a cleaning thread bundle.

The optical connector cleaning tool 302 includes the cleaning thread bundle 13, the cleaning sheet 14, a cleaning sheet holding section 15, a spring holding section 16, a spring 17, a retraction spring 46 of an optical connector plug fixing tool 30, and a movement mechanism, inside an optical connector cleaning tool housing 11 provided with the optical connector plug fixing tool 30. The structure of the movement mechanism is the same as that of the optical connector cleaning tool 301 of FIG. 1.

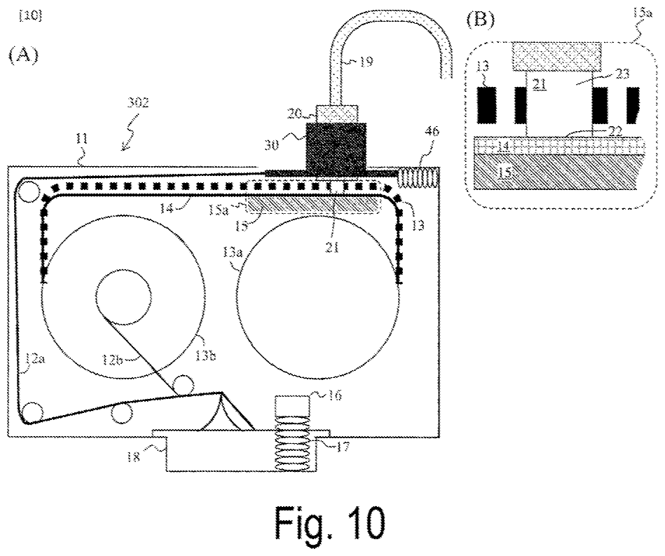

An optical connector cleaning method of the present invention will be described referring to FIGS. 10 to 12. The optical connector cleaning tool 302 has a feature in which the fixing section 30 performs the following two operations while holding the optical connector plug 20. The first operation is an operation of movement from an initial position to an end position in a movement direction of the cleaning bands (13, 14) in conjunction with an operation of moving, by the movement mechanism, the cleaning bands (13, 14) by a given amount. The second operation is an operation of returning from the end position to the initial position after the operation of moving, by the movement mechanism, the cleaning bands (13, 14) by the given amount.

First, as illustrated in FIG. 10, the optical connector plug 20 attached to an optical fiber cord 19 is inserted into the optical connector fixing tool 30. Then, as in FIG. 4, the ferrule 21 is inserted into the cleaning thread bundle 13, and the optical connector plug 20 is pushed into the optical connector fixing tool 30 until the ferrule end surface 22 reaches the cleaning sheet 14. Here, the optical connector fixing tool 30 can be provided with for example a hook (not illustrated) on the inside, which is fit into a groove in a side surface of the optical connector plug thereby fixing the optical connector plug 20. Fixing may be performed using other methods.

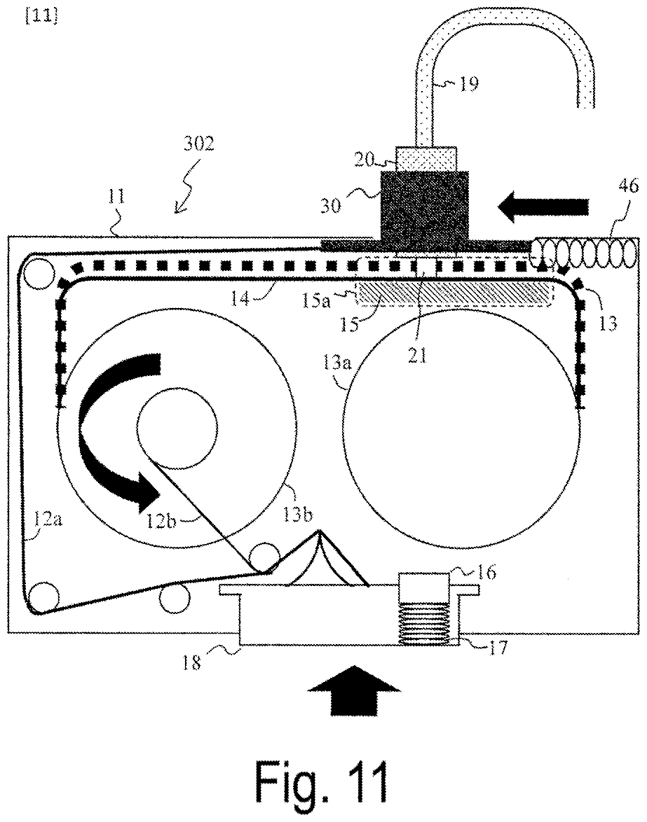

Next, as illustrated in FIG. 11, pressure is applied to the drive button 18 in a direction of an arrow from below, whereby a string 12a for the optical connector plug fixing tool connected to the drive button 18 is pulled, and the optical connector plug fixing tool 30 is moved from right to left in a direction of an arrow. At the same time, a retraction spring 46 for retracting the optical connector plug fixing tool 30 is extended. Similarly to the optical connector cleaning tool 301 of FIG. 1, a string 12b for the cleaning thread bundle and the cleaning sheet connected to the drive button 18 is pulled and a winding reel 13b is rotated counterclockwise in a direction of an arrow. As in the description of the optical connector cleaning tool 301 of FIG. 1, new cleaning bands (13, 14) are revealed in a cleaning section 15a with rotation of a feeding reel 13a and the winding reel 13b.

Here, although the movement of the optical connector plug fixing tool 30 and the feeding of the cleaning bands (13, 14) are driven by the strings (12a, 12b) connected to the drive button 18, respectively, other methods that enable the movement of the optical connector plug fixing tool 30 and the feeding of the cleaning bands (13, 14) may be used.

As in the description of the optical connector cleaning tool 301 of FIG. 1, a stopper (not illustrated) is attached to the cleaning bands (13, 14). For this reason, even though the drive button 18 is released and the drive button 18 returns to an original state by the spring 17, the cleaning bands (13, 14) do not return to an original position (the used portions are not revealed again in the cleaning section 15a). The stopper may be attached to the reels (13a, 13b).

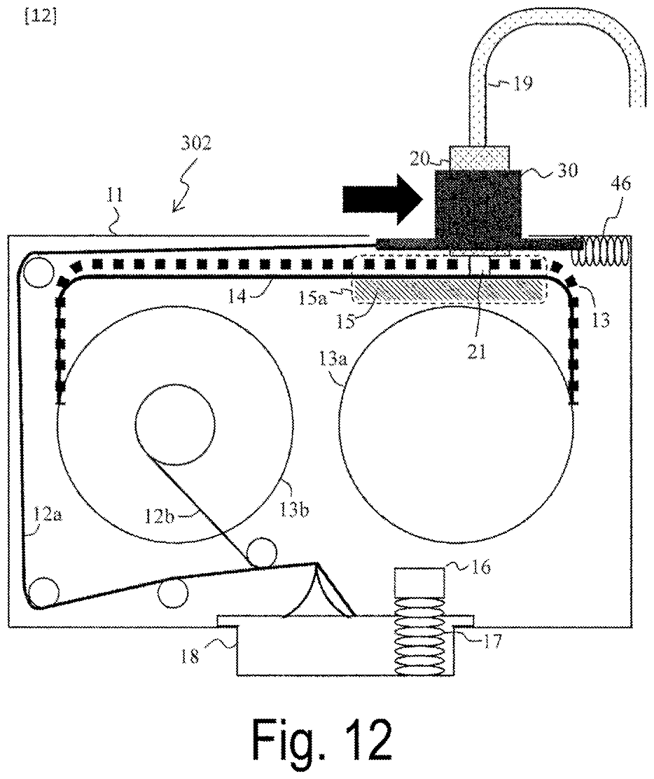

Subsequently, as illustrated in FIG. 12, in a case where the drive button 18 is released and the drive button 18 returns to the original state by the spring 17, the string 12a for the optical connector plug fixing tool is released and the optical connector plug fixing tool 30 is moved from left to right by force of the retraction spring 46. In this case, since the cleaning bands (13, 14) are not moved by the above-described stopper, the ferrule end surface 22 and the ferrule side surface 23 are rubbed and cleaned with the cleaning sheet 14 and the cleaning thread bundle 13, respectively.

The fixing section 30 may include a rotation mechanism that rotates the optical connector plug 20 by 180° or more about the center of the ferrule 21 when the fixing section 30 returns from the end position to the initial position.

To rotate the ferrule side surface 23 by 180 degrees or more at the time of a single cleaning operation, for example, the optical connector cleaning tool housing 11 includes a rack (not illustrated), and the optical connector plug fixing tool 30 includes a pinion (not illustrated), as the rotation mechanism. The pinion that meshes with the rack is rotated along with the movement of the optical connector plug fixing tool 30, whereby the optical connector plug fixing tool 30 itself is rotated. With the rotation of the optical connector plug fixing tool 30, the optical connector plug 20, that is, the ferrule 21 is rotated. In a case where the ferrule 21 is rotated by 180 degrees, the ferrule side surface can be cleaned at 360 degrees.

Although a case where the rotation mechanism includes the rack and the pinion has been described, methods other than described above may be used.

In the embodiment, although a case where the side surface cleaning band 13 is a cleaning thread bundle has been described, the side surface cleaning band 13 may be a cleaning sheet as in the second embodiment.

The respective structures of the embodiments described above can be combined as much as possible.

### Additional Description

The following describes the optical connector cleaning tool of the present invention.
Each of the optical connector cleaning tools of the first and second embodiments is an optical connector cleaning tool that cleans the end surface and the side surface of the ferrule of the optical connector plug. Then, the optical connector cleaning tool has a feature in which the end surface cleaning section and the side surface cleaning section are integrally combined to have the following function, and the ferrule of the optical connector plug can be repeatedly cleaned. Here, the end surface cleaning section is a cleaning section that cleans the end surface of the ferrule of the optical connector plug. The side surface cleaning section is a cleaning section that cleans the ferrule side surface of the optical connector plug. The following function is a function in which the end surface cleaning section and the side surface cleaning section can reveal respective new cleaning portions at a predetermined position after a single cleaning operation.

The optical connector cleaning tool of the first embodiment has a feature in which the end surface cleaning section includes a cleaning sheet, and the side surface cleaning section includes a cleaning thread bundle.

In the housing having the opening at a predetermined position, a wide surface of the cleaning sheet of the end surface cleaning section is disposed in a path passing between the shutter for providing the opening only at the time of a cleaning operation and the cleaning sheet holding section fixedly provided below the shutter. The cleaning thread bundle of the side surface cleaning section is disposed between the shutter and the cleaning sheet in the housing. Then, the unused portions of the cleaning sheet and the cleaning thread bundle are wound around the reel on the feeding side, and the used portions of the cleaning sheet and the cleaning thread bundle are wound around the reel on the winding side.

The optical connector cleaning tool of the first embodiment has a feature of including the push section for feeding the cleaning sheet and the cleaning thread bundle, the spring for restoring the feeding and pushing section, and the spring holding section that regulates the position of the spring. Here, the push section for the feeding is connected to the shutter and the reel on the winding side through the strings. The cleaning sheet and the cleaning thread bundle are moved such that new portions are located in the opening when the shutter is opened for each single pushing operation.

The optical connector cleaning tool of the second embodiment has a feature in which the end surface cleaning section and the side surface cleaning sections include cleaning sheets, and each cleaning sheet attached to the corresponding side surface cleaning section is fixed not to be twisted at the time of ferrule cleaning.

In the housing having the opening at a predetermined position, a wide surface of the cleaning sheet of the end surface cleaning section is disposed in a path passing between the shutter for providing the opening only at the time of a cleaning operation and the cleaning sheet holding section fixedly provided below the shutter. Then, the two cleaning sheets of the side surface cleaning sections are disposed to be perpendicular to the cleaning sheet of the end surface cleaning section between the shutter and the cleaning sheet of the end surface cleaning section in the housing. Then, the unused portions of the cleaning sheets of the end surface cleaning section and the side surface cleaning section are wound around the reel on the feeding side, and the used portions of the cleaning sheets of the end surface cleaning section and the side surface cleaning section are wound around the reel on the winding side.

The optical connector cleaning tool of the second embodiment has a feature of including the push section for feeding the cleaning sheets, the spring for restoring the push section for the feeding, and the spring holding section that regulates the position of the spring. Here, the push section for the feeding is connected to the shutter and the reel on the winding side through the strings. The cleaning sheets of the end surface cleaning section and the side surface cleaning section are moved such that the new portions are located in the opening when the shutter is opened for each single pushing operation.

The optical connector cleaning tool of the third embodiment is an optical connector cleaning tool that cleans the end surface and the side surface of the ferrule of the optical connector plug. The optical connector cleaning tool has a feature in which the end surface cleaning section, the side surface cleaning section, the fixing section, and the ferrule movable section are integrally combined to have the following function, and the ferrule of the optical connector plug can be repeatedly cleaned. Here, the end surface cleaning section is a cleaning section that cleans the end surface of the ferrule of the optical connector plug. The side surface cleaning section is a cleaning section that cleans the ferrule side surface of the optical connector plug. The fixing section fixes the optical connector plug. The ferrule movable section slides the ferrule end surface while rotating the ferrule side surface of the optical connector plug. The following function is a function in which the ferrule movable section rotates the ferrule side surface by 180 degrees or more at the time of a single cleaning operation, and the end surface cleaning section and side surface cleaning section can reveal the new cleaning portions at a predetermined position after the single cleaning operation.

The optical connector cleaning tool according to the third embodiment has a feature in which the end surface cleaning section includes the cleaning sheet and the side surface cleaning section includes the cleaning thread bundle.

In the housing having the fixing section at a predetermined position, a wide surface of the cleaning sheet of the end surface cleaning section is disposed in a path passing between the fixing section and the cleaning sheet holding section fixedly provided below the fixing section. The cleaning thread bundle of the side surface cleaning section is disposed between the fixing section and the cleaning sheet in the housing. Then, the unused portions of the cleaning sheet and the cleaning thread bundle are wound around the reel on the feeding side, and the used portions of the cleaning sheet and the cleaning thread bundle are wound around the reel on the winding side.

The optical connector cleaning tool of the third embodiment has a feature of including the push section for feeding the cleaning sheet and the cleaning thread bundle, the spring for restoring the push section for the feeding, and the spring holding section that regulates the position of the spring. Here, the push section for the feeding is connected to the shutter and the reel on the winding side through the strings and moves the cleaning sheet and the cleaning thread bundle such that new portions are located below the fixing tool when the fixing section is reciprocated for each single pushing operation.

In the optical connector cleaning tool of the third embodiment, similarly to the optical connector cleaning tool of the second embodiment, the end surface cleaning section and the side surface cleaning section may include cleaning sheets, and each cleaning sheet attached to the corresponding side surface cleaning section may be fixed not to be twisted at the time of ferrule cleaning.

In this case, in the housing having the fixing section at a predetermined position, a wide surface of the cleaning sheet of the end surface cleaning section is disposed in a path passing between the fixing section and the cleaning sheet holding section fixedly provided below the fixing section. Then, the two cleaning sheets of the side surface cleaning section are disposed to be perpendicular to the cleaning sheet of the end surface cleaning section between the fixing section and the cleaning sheet of the end surface cleaning section in the housing. Then, the unused portions of the cleaning sheets of the end surface cleaning section and the side surface cleaning section are wound around the reel on the feeding side, and the used portions of the cleaning sheets of the end surface cleaning section and the side surface cleaning section are wound around the reel on the winding side.

In this case, the optical connector cleaning tool of the third embodiment is configured to include the push section for feeding the cleaning sheets, the spring for restoring the push section for the feeding, and the spring holding section that regulates the position of the spring. Here, the push section for the feeding is connected to the shutter and the reel on the winding side through the strings and moves the cleaning sheets of the end surface cleaning section and side surface cleaning section such that new portions are located below the fixing tool when the fixing section is reciprocated for each single pushing operation.

The optical connector cleaning tool of the present invention removes dust and other foreign substances attached to the ferrule end surface and side surface of the optical connector plug with the cleaning sheet and the cleaning thread bundle. With this, it is possible to provide an optical connector cleaning tool capable of simultaneously and appropriately cleaning the end surface and the side surface of the ferrule of the optical connector plug. Here, the foreign substances other than dust are, for example, hand oil and the like.

### INDUSTRIAL APPLICABILITY

The optical connector cleaning tool according to the present invention can simultaneously and appropriately clean the end surface and the side surface of the ferrule of the optical connector plug. As a result, it is possible to beneficially utilize the optical connector cleaning tool for optical connector connection in the wiring of the optical communication network.

### REFERENCE SIGNS LIST

10 Insertion port
11 Housing
12 Shutter
13 Side surface cleaning band (cleaning thread bundle)
14 End surface cleaning band (cleaning sheet)
15 Cleaning sheet holding section
15a Cleaning section
16 Spring holding section
17 Spring
18 Drive button
19 Optical fiber cord
20 Optical connector plug
21 Ferrule
22 Ferrule end surface
23 Ferrule side surface
24 Side surface cleaning band (cleaning sheet)
25 Twist prevention wall
30 Optical connector plug fixing tool
46 Retraction spring

1. An optical connector cleaning tool comprising:
an insertion port into which a ferrule of an optical connector plug is inserted;
an end surface cleaning band configured to remove dirt on a ferrule end surface of the optical connector plug by friction with the ferrule end surface;
a side surface cleaning band configured to remove dirt on a ferrule side surface of the optical connector plug by friction with the ferrule side surface;
a cleaning section configured to bring the ferrule end surface and the ferrule side surface of the optical connector plug inserted from the insertion port into contact with portions of the end surface cleaning band and the side surface cleaning band, respectively; and
a movement mechanism configured to move the end surface cleaning band and the side surface cleaning band by a given amount, move portions of the end surface cleaning band and the side surface cleaning band revealed in the cleaning section, and reveal new portions of the end surface cleaning band and the side surface cleaning band in the cleaning section.

2. The optical connector cleaning tool according to claim 1,
wherein the end surface cleaning band is a cleaning sheet, and
the side surface cleaning band is a cleaning thread bundle.

3. The optical connector cleaning tool according to claim 1,
wherein the end surface cleaning band and the side surface cleaning band are cleaning sheets.

4. The optical connector cleaning tool according to claim 3, further comprising:
a twist prevention wall configured to prevent the side surface cleaning band from being twisted when the side surface cleaning band is brought into contact with the ferrule side surface, the twist prevention wall being located on a side opposite to a side of the side surface cleaning band that is to be in contact with the ferrule side surface.

5. The optical connector cleaning tool according to any one of claims 1 to 4,
wherein the movement mechanism includes:
a feeding reel configured to feed the end surface cleaning band and the side surface cleaning band,
a winding reel configured to wind the end surface cleaning band and the side surface cleaning band; and
a drive button configured to drive the winding reel.

6. The optical connector cleaning tool according to any one of claims 1 to 5, further comprising:
a shutter configured to close the insertion port,
wherein the shutter is opened and closed in conjunction with an operation of moving, by the movement mechanism, the end surface cleaning band and the side surface cleaning band by a given amount.

7. The optical connector cleaning tool according to any one of claims 1 to 5, further comprising:
a fixing section located in the insertion port, the fixing section being configured to hold the optical connector plug in a state in which the ferrule end surface and the ferrule side surface of the optical connector plug are in contact with portions of the end surface cleaning band and the side surface cleaning band, respectively,
wherein, while holding the optical connector plug, the fixing section moves from an initial position to an end position in a movement direction of the end surface cleaning band and the side surface cleaning band in conjunction with an operation of moving, by the movement mechanism, the end surface cleaning band and the side surface cleaning band by a given amount, and returns from the end position to the initial position after the operation of moving, by the movement mechanism, the end surface cleaning band and the side surface cleaning band by the given amount.

8. The optical connector cleaning tool according to claim 7,
wherein the fixing section includes a rotation mechanism configured to rotate the optical connector plug by 180° or more about a ferrule center of the optical connector plug as an axis when the fixing section returns from the end position to the initial position.
